(19) United States
(12) Patent Application Publication
(10) Pub. No.: US 2026/0099040 A1
(43) Pub. Date: Apr. 9, 2026

(54) DEFORMABLE MIRROR ACTUATORS AND USES THEREOF

(71) Applicant: Kratos SRE, Inc., Birmingham, AL (US)

(72) Inventor: James R. Tucker, Hoover, AL (US)

(21) Appl. No.: 19/345,291

(22) Filed: Sep. 30, 2025

Related U.S. Application Data
(60) Provisional application No. 63/702,264, filed on Oct. 2, 2024.

(51) Int. Cl. G02B 26/08; G02B 7/18

(52) U.S. Cl. CPC G02B 26/0866; G02B 7/1815

(57) ABSTRACT

The present invention discloses deformable mirror (“DM”) actuators and, in particular, deformable mirrors or segments of deformable mirrors, wherein the DMs or DM segments include a mirror layer and a reaction structure portion, and wherein plurality of DM actuators are interposed between the mirror layer and the reaction structure portion, and wherein each DM actuator of the plurality of DM actuators is configured to operate as a discrete thermal expansion piston.

### CROSS-REFERENCE

This application claims priority to U.S. Provisional Patent App. No. 63/702,264, filed Oct. 2, 2024, and titled “DEFORMABLE MIRROR ACTUATORS,” the contents of which are incorporated by reference herein in their entirety.

### FIELD

This disclosure relates to mirrored surfaces, and more particularly, to systems and methods for using deformable mirror (DM) actuators.

### BACKGROUND

Different types of deformable mirror (DM) actuator technologies have been developed for commercial applications. Various actuators leverage voltage to induce a mechanical deformation, and in some cases demand relatively high voltage (for example, on the order of about 100.0 volts (V)). Although sometimes optimized for normal conditions or broad commercial applications, various actuators are not necessarily qualified or rated for extreme conditions or for specialty-applications with stringent performance requirements. For example, both piezoelectric actuators and MEMS actuators suffer from “scale-up” issues, in that any application demanding hundreds or thousands of actuators would also require a corresponding or scaled quantity of electrical connections and wires/cables. In this way, piezoelectric actuators and MEMS actuators are unhelpful for specialty-applications with limited physical space for wires or cables, and for specialty-application where the required stroke length is short (e.g., less than about 10.0 picometers) and where unintentional variance is unacceptable (e.g., where DM surface stability of about 10 picometers per hour or less is required).

In various contexts, for example space applications and advanced aviation applications, challenges remain in developing DM actuators and in developing systems and methods of using the same that mitigate these deficiencies. Therefore, the inventors have identified a need for improved DM actuators, and for improved systems and methods of using the same.

### SUMMARY

In some aspects, the techniques described herein relate to DM actuators and, in particular, to deformable mirrors or segments of deformable mirrors, wherein the DMs or DM segments include a mirror layer and a reaction structure portion, and wherein plurality of DM actuators are situated between the mirror layer and the reaction structure portion, and wherein each DM actuator of the plurality of DM actuators is configured to operate as a discrete thermal expansion piston.

In some aspects, the techniques described herein relate to a DM or a segment of a DM, wherein the DM or DM segment includes: a mirror layer that is of a thickness that when pushed upon, by a DM actuator(s), will locally deform within a unit area of the DM or DM segment; and a reaction structure portion that allows radiation, specifically, light from a light source, fiber optic, or laser beam, to traverse the reaction structure portion without being significantly absorbed, allowing for the actuators/pistons to be radiantly-heated.

In accordance with another aspect of the disclosure, a deformable mirror is provided. An example deformable mirror includes a deformable mirror layer, a reaction structure layer, and a plurality of actuators between the deformable mirror layer and the reaction structure layer. The plurality of actuators engage the back of the deformable mirror layer and each actuator of the plurality of actuators is configured to push against a local area of the deformable mirror layer in response to thermal expansion from a non-contact heat source and/or pull the local area of the deformable mirror layer in response to thermal contraction from the non-contact heat source.

In some embodiments of the deformable mirror, the plurality of actuators are configured to each actuate to a target amount based on a thickness, a shape, a coefficient of thermal expansion, a specific heat, an emissivity, or a thermal conductivity.

In some embodiments of the deformable mirror, the reaction structure layer includes a heat sink that dissipates heat from the plurality of actuators to a stable state.

In some embodiments of the deformable mirror, the heat sink regulates temperature utilizing a thermoelectric source, a mechanical source, or a liquid source.

In some embodiments of the deformable mirror, the plurality of actuators includes different actuators that actuate to different target amounts in response to a same applied heat.

In some embodiments of the deformable mirror, the plurality of actuators includes a discrete thermal expansion piston.

In some embodiments of the deformable mirror, the deformable mirror layer includes a coating with a thickness at each location of the deformable mirror location, where the thickness at a location defines deformation of the location that adjusts a reflected waveform to a desired waveform.

In some embodiments of the deformable mirror, the reaction structure layer includes a plurality of channels corresponding to a plurality of local areas of the deformable mirror layer.

In some embodiments of the deformable mirror, the plurality of local areas are each aligned with at least one light source, where light from the at least one light source traverses through at least one of the plurality of channels to heat at least one actuator of the plurality of actuators.

In some embodiments of the deformable mirror, the reaction structure layer includes a stable plane against which the plurality of actuators performs the push and/or the pull.

In some embodiments of the deformable mirror, the reaction structure layer includes a transparent or a translucent layer, where the transparent layer or the translucent layer has a thermal conductivity that exceeds a target threshold.

In some embodiments of the deformable mirror, the plurality of actuators are aligned with the non-contact light source comprising a digital light processing (DLP) chip, where light from the DLP chip applies non-contact radiant heat to the plurality of actuators.

In another aspect of the disclosure, a deformable mirror segment is provided. An example deformable mirror segment includes a deformable mirror layer, a reaction structure layer, a plurality of actuators between the deformable mirror layer and the reaction structure layer, and at least one light source aligned with the plurality of actuators. The plurality of actuators engage the back of the deformable mirror layer and each actuator of the plurality of actuators is configured to push against a local area of the deformable mirror layer in response to thermal expansion from non-contact heat sourced from the at least one light source and/or pull the local area of the deformable mirror in response to thermal contraction from removal of the non-contact heat sourced from at least one light source.

In some embodiments of the deformable mirror segment, at least one light source comprises at least one modulated laser.

In some embodiments of the deformable mirror segment, the at least one modulated laser comprises a fast-steering mirror.

In some embodiments of the deformable mirror segment, at least one light source is spatially varied using a transparent Liquid Crystal Display (LCD) as a mask.

In some embodiments of the deformable mirror segment, modulated light is delivered to discrete actuators of the plurality of actuators via a fiber optic cable.

In some embodiments of the deformable mirror segment, the at least one light source is spatially varied using a digital light processing chip.

In accordance with another aspect of the disclosure, a method is provided. The method in some embodiments is provided for deforming a mirror. An example method includes activating a non-contact heat source aligned with a deformable mirror. The non-contact heat source produces non-contact heat in response to being activated. The deformable mirror comprises a deformable mirror layer, a reaction structure layer, and a plurality of actuators between the deformable mirror layer and the reaction structure layer. The example method further includes heating the plurality of actuators using the non-contact heat source. In response to the heating, the plurality of actuators are configured to thermally expand and push against a local area of the deformable mirror layer. The non-contact heat traverses through the reaction structure layer. The example method further includes deactivating the non-contact heat source. In response to deactivating the non-contact heat source, the plurality of actuators are configured to thermally contract and/or pull the local area of the deformable mirror layer in response to the thermal contraction.

In some embodiments of the method, the non-contact heat source comprises a digital light processing chip.

In some embodiments of the method, the non-contact heat source comprises at least one modulated laser.

In some embodiments of the deformable mirror segment, the non-contact heat source comprises a Liquid Crystal Display (LCD) mask.

In some embodiments of the deformable mirror segment, the non-contact heat is delivered to discrete actuators of the plurality of actuators via a fiber optic cable.

In some embodiments of the method, the plurality of actuators actuate to different target amounts in response to a same applied heat.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 depicts a perspective view of an illustration of an example of a deformable mirror (DM) segment comprising a plurality of DM actuators according to at least some embodiments of the present disclosure;

FIG. 2 depicts a perspective view of an illustration of an example of a DM segment comprising: a plurality of DM actuators; and a transparent or translucent reaction structure portion, according to at least some embodiments of the present disclosure;

FIG. 3 depicts a perspective view of an illustration of an example of a DM segment comprising a plurality of DM actuators and heated by light from a light source distributed using a digital light processing (DLP) chip, according to at least some embodiments of the present disclosure;

FIG. 4 depicts a perspective view of an illustration of an example of a DM segment comprising a plurality of DM actuators and heated by light from a light source distributed using a fast-steering mirror, according to at least some embodiments of the present disclosure;

FIG. 5 depicts a table showing the stroke length of a DM actuator made possible by different materials, according to at least some embodiments of the present disclosure; and

FIG. 6 depicts operations of deforming a mirror for using the deformable mirror in accordance with at least some embodiments of the disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout.

The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising”are used in a non-exclusive sense, except where the context requires otherwise.

Likewise, the term “includes” and its grammatical variants are intended to be non-limiting, such that recitation of items in a list is not to the exclusion of other like items that can be substituted or added to the listed items.

Conventional DM actuators suffer from various deficiencies. For example, conventional DM actuator technologies include electrostrictive/piezoelectric actuators, and electrostatically-forced micro electro-mechanical systems (MEMS) are used as actuators. In either case, such implementations demand high voltages and often cannot fit in space-constrained designs. Addressing such deficiencies is desirable.

Conventional DM actuators, such as mechanically-actuated actuators or resistively-heated actuators (e.g., piezoelectric actuators and MEMS actuators) additionally suffer from “scale-up” issues. For example, as the demand for DM's with an ever-increasing number of actuators grows (for finer wave front control), the logistics of practically implementing a plurality of mechanically-actuated actuators using piezoelectric elements becomes difficult. For example, a one-inch mirror with a 100×100 array of actuators would require 20,000 wires attached to the mirror and 10,000 voltage control devices. Such resource requirements are not feasible for implementation.

Resistively-heated actuators have a similar problem to the mechanically-actuated actuators. For example, a one-inch mirror with a 100×100 array of actuators would also require 20,000 wires and 10,000 current control devices. The 20,000 wires do not need to be in direct contact with the back of the mirror (as with the mechanically-actuated type); however, the further the wire contacts are positioned from the mirror, the greater the need for longer thermal expansion and/or stroke length. This reduces control fidelity and creates complications for managing the reversal of expansion (e.g., the contraction), back to a base state or somewhere in between.

Abandoning discrete actuators, and relying on directly deforming and/or shaping the mirror (e.g., directly heating the mirror material with radiant heat), does not adequately remedy these deficiencies. In particular, radiantly-heated DMs without discrete actuators have limited spatial control of the mirror figure due to thermal conductivity of the mirror and its heated substrate or support structure.

As such, systems and methods according to the present disclosure address these limitations and deficiencies and, in one example aspect, overcome many of the limitations of conventional DM actuator technologies. Embodiments of the present disclosure provide advantages and overcome limitations and deficiencies specifically in those implementations demanding high actuator density.

### I. Example Use Case Scenario

The actuators described herein, and the systems and methods of using the same, present a novel approach and one or more technical steps and/or solutions to addressing the challenges and deficiencies in the prior art.

For example, in one aspect, the systems and methods according to the present disclosure leverage a plurality of independent, discrete actuators whose response to an amount of radiant heat (or heat flux) over a period of time is tailored by design of their thickness, shape, coefficient of thermal expansion (CTE), specific heat, emissivity, and/or thermal conductivity, to optimize sensitivity, response, and recovery time of the actuator.

In another aspect, systems and methods according to the present disclosure leverage a plurality of actuators, wherein each actuator is made of material(s) configured for thermal expansion controlled by non-contact radiant heat from one or more spatially-and/or temporally-variable source(s) of radiation.

In another aspect, systems and methods according to the present disclosure leverage a plurality of actuators that operate as discrete thermal expansion pistons for active/passive displacement, for example, for active or passive change in length or other dimension of the piston.

In another aspect, systems and methods according to the present disclosure leverage a plurality of discrete piston-like actuators for active/passive displacement wherein, depending on the piston material(s), an amount of radiant heat (or heat flux) over a period of time results in a stroke length for each piston, in an embodiment, of about 0.5 picometers and, in another embodiment, of about 50.0 nanometers.

In another aspect, systems and methods according to the present disclosure leverage a plurality of discrete piston-like actuators for active/passive displacement wherein, depending on the piston material(s), an amount of radiant heat (or heat flux) over a period of time allows for single digit picometer displacement control.

In another aspect, systems and methods according to the present disclosure leverage a plurality of discrete piston-like actuators, wherein each piston is capable of single digit picometer stability over many minutes to an hour.

In another aspect, systems and methods according to the present disclosure leverage a plurality of discrete piston-like actuators, wherein each piston is thermally connected to a reaction structure, that is not intended to expand, but whose absorption and/or physical characteristics and structures allows light (or one or more types of radiation) to traverse the reaction structure and radiantly heat the targeted piston(s).

In another aspect, systems and methods according to the present disclosure leverage a plurality of discrete piston-like actuators, wherein each piston is thermally connected to a reaction structure, and wherein the reaction structure acts as a heat sink facilitating the actuators returning to a base state, in a timely and/or predictable manner, when the amount of radiant heat (or heat flux) over a period of time is changed or removed.

In another aspect, systems and methods according to the present disclosure leverage a plurality of discrete piston-like actuators, wherein each piston is configured to receive direct or indirect (e.g., reflected, directed, separated, channeled) radiation from one or more spatially- and/or temporally-variable source(s) of radiation.

In another aspect, systems and methods according to the present disclosure leverage a plurality of DM actuators, wherein each DM actuator is configured to precisely adjust a unit area of a mirror, such that the plurality of DM actuators can correct for imperfections or shape change the mirror, and/or allow for small adjustments in a reflected wave front (in the order of picometers, in an embodiment, and in the order of tens of nanometers, in another embodiment).

In another aspect, systems and methods according to the present disclosure leverage a plurality of DM actuators that adjust the optical path of incoming light by individually (or in groups) changing the shape of reflective mirror region(s) or area(s). By adjusting the shape of a reflective mirror region or area, it is possible to correct the wave front that is perturbated by optical aberrations upstream or downstream of the DM.

In another aspect, systems and methods according to the present disclosure leverage a plurality of DM actuators, wherein the number of individual actuators is proportional to the correctable field of view.

### II. Systems and Methods

In one aspect, the present disclosure provides an actuator, and systems and methods for using the same.

In one aspect, the present disclosure provides a plurality of actuators, wherein each actuator can be varied in thickness, shape, coefficient of thermal expansion (CTE), specific heat, emissivity, and/or thermal conductivity to optimize sensitivity, response, and recovery time of the actuator action.

In one aspect, the present disclosure provides a plurality of actuators, wherein each actuator includes one or more of the group consisting of INVAR 36™, ZERODUR™ class 0, ULE 797™, copper, and molybdenum, or is made of any other material(s), composite(s), or combination(s) configured for thermal expansion controlled by non-contact radiant heat from one or more spatially- and/or temporally-variable source(s) of radiation.

In one aspect, the present disclosure provides a plurality of actuators, wherein each actuator is configured to receive reflected, directed, separated, distributed, and/or channeled radiation from, for example, a light source that is spatially and intensity-varied using a digital light processing (DLP) chip (as is commonly found in some projection televisions and in some resin-cure 3D printers), or from a modulated laser source that is spatially and intensity-varied using one or more fast-steering mirrors (as are used in some selective laser-melt 3D printers).

In one aspect, the present disclosure provides a plurality of actuators, wherein each actuator is configured to receive radiation from, for example, light from a light source traveling through a shutter-like structure, for example an LCD mask.

In one aspect, the present disclosure provides a plurality of actuators, wherein each actuator is actuated by radiant heat generated by a radiation source that precisely and accurately deposits heat energy to a targeted actuator or group of actuators, without significantly heating a reaction structure by directing, focusing, or delivering via a fiber optic.

In one aspect, the present disclosure provides a plurality of actuators, wherein each actuator can be actuated by radiant heat generated by multiple, redundant radiation sources (removing the risk of a dead pixel/dead unit area of a DM segment, or of an entirely dead DM segment).

In one aspect, the present disclosure provides a plurality of actuators, wherein each actuator is thermally connected to a reaction structure configured to operate as a stable reference plane (against which the actuators can push and/or pull), and configured to operate as a heat sink to remove heat energy from each actuator.

In one aspect, the present disclosure provides a plurality of actuators, wherein each actuator is thermally connected to a reaction structure that is sufficiently transparent, translucent, or with adsorption characteristics allowing light (or one or more types of radiation) to traverse the reaction structure and to radiantly heat the targeted actuator(s).

In one aspect, the present disclosure provides a plurality of actuators, wherein each actuator is thermally connected to a reaction structure that is a solid transparent material, for example, fused silica or BK7™.

In one aspect, the present disclosure provides a plurality of actuators, wherein each actuator is thermally connected to a reaction structure that defines optical channels, ports, lenses, and/or other physical characteristics or structures allowing radiation to traverse the reaction structure and to radiantly heat the targeted actuator(s).

In one aspect, the present disclosure provides a plurality of actuators, wherein each actuator is thermally connected to a reaction structure that is significantly stiffer than the material of the actuators.

In one aspect, the present disclosure provides a plurality of actuators, wherein each actuator is thermally connected to a reaction structure configured as, or including, a thermoelectric cooler (to balance total radiant power input), or as a constant-temperature heat sink using thermoelectric, mechanical, liquid, or other temperature regulating source(s).

In one aspect, the present disclosure provides a plurality of DM actuators, wherein each DM actuator is configured to precisely adjust a unit area of a metallic or glass mirror with a metallic or reflective coating that is of a thickness that when pushed upon from the back side will locally deform the unit of area of the mirror to influence the mirror figure, and hence, alter any reflected wave front in a controllable manner.

In one aspect, the present disclosure provides a DM system wherein the DM is made of ULE Zerodur™, CLEARCERAM-Z, or similar optical ceramic.

In one aspect, the present disclosure provides a DM system wherein the thickness of the DM can be varied to control the deformation of a unit area for a given actuator load and to affect the shape and function between actuator locations.

In one aspect, the present disclosure provides a DM system wherein a plurality of actuators are attached to or against the back of a DM such that, when their temperature is changed, due to their thermal expansion or contraction, the targeted actuators or pistons will push or pull on the back of the mirror to locally deform a unit area(s), to influence the mirror figure, and hence, to alter any reflected wave front in a controllable manner.

In one aspect, the present disclosure provides a plurality of actuators, wherein each actuator is actuated by radiant heat generated by a radiation source that precisely and accurately deposits heat energy to a targeted actuator or group of actuators, without significantly heating a reaction structure or a mirror, such that thermal expansion actuates the targeted actuators or group of actuators, resulting in precise control of mirror deformation to influence the mirror figure, and hence, alter any reflected wave front in a controllable manner.

In one aspect, the present disclosure provides a DM system wherein the actuator elements are the same material as the mirror and or a monolithic part of the mirror.

In one aspect, the present disclosure provides a DM system wherein the actuator elements are the same material as the reaction structure and or a monolithic part of the reaction structure.

In one aspect, the present disclosure provides a DM system wherein the mirror diameter is between about 1.0 inch to about 4.0 inches.

In one aspect, the present disclosure provides a DM system wherein the mirror diameter is between about 1.0 inch to about 20.0 inches.

In one aspect, the present disclosure provides a DM system having a plurality of actuators thermally connected to a reaction structure that is significantly stiffer than the material(s) of the actuators, and stiffer than the mirror material(s).

In one aspect, the present disclosure provides a DM system with millikelvin temperature control, which effectively allows for picometer adjustment of specific unit area(s) of the mirror.

In one aspect, the present disclosure provides a DM system for space applications demanding total stroke requirements less than a micrometer, DM surface height resolution of about ten picometers, and DM surface stability of about ten picometers per hour.

In one aspect, the present disclosure provides a DM system wherein the same configuration and arrangement of parts can meet NASA™-type deformable mirror requirements and commercial application type requirements simply by varying the material of the DM actuators and/or by varying the update/refresh rate of the heat input.

### III. With Reference to the Figures

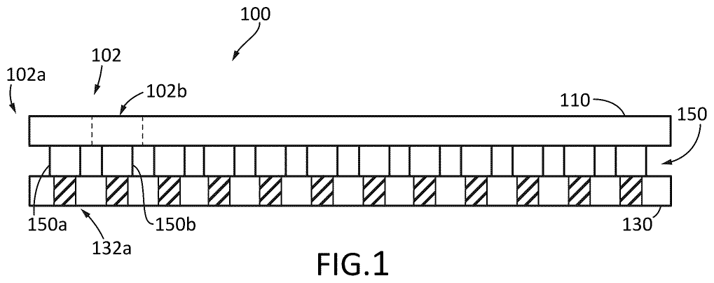

FIG. 1 depicts a perspective view of an illustration of an example of a deformable mirror (DM) segment comprising a plurality of DM actuators. In particular, in one aspect, the DM segment 100 is made up of a plurality of unit areas 102, and the DM segment may be one of many DM segments making up (or part of) a larger structure, device, or system. FIG. 1, is not illustrated to scale and is not limited to the dimensions or relative proportions as shown.

In another aspect, as illustrated in FIG. 1, the DM segment 100 includes a mirror layer 110, a reaction structure portion 130, and a plurality of DM actuators 150 interposed between the mirror layer 110 and the reaction structure portion 130, each corresponding to the individual unit areas (102a, 102b, etc.) of the plurality of unit areas 102. An actuator, or a plurality of actuators such as the plurality of DM actuators 150, are attached to or against a back side of the mirror layer 110. In this way, in one aspect, each DM actuator (150a, 150b, etc.) of the plurality of DM actuators 150 is configured to operate as a discrete thermal expansion piston for active/passive displacement, such that when the temperature of a DM actuator changes, the DM actuator pushes and/or pulls back locally to deform a location in the mirror accordingly. For example, in one aspect, for unit area 102a, the DM actuator 150a of the plurality of DM actuators 150 is configured to operate as a discrete thermal expansion piston that actively or passively changes its length towards or away from the mirror layer 110.

In another aspect, as illustrated in FIG. 1, in some embodiments the mirror layer 110 is a metallic or glass mirror. The mirror layer 110 in some such embodiments has a metallic or reflective coating that is of a thickness that, when pushed upon by a DM actuator of the plurality of DM actuators 150, will locally deform within the unit area(s) of the plurality of unit areas 102. In this regard, the deformation influences the mirror's figure, and alters any reflected wavefront. Using the actuator to deform in a particular, controlled manner enables the reflected waveform to be altered in a similarly controllable manner. In some embodiments, the thickness of a DM (or of the metallic or reflective coating specifically, for example) is defined to control the deformation for a given actuator load, such that a particular actuator load results in a particular desired deformation and corresponding alteration of a reflected waveform. Additionally or alternatively, in some embodiments, the thickness is defined such that the deformations at particular locations alter the shape function at each of such particular locations to match a desired shape function upon and/or during alteration by the actuator (or actuators). Moreover, in another aspect, the mirror layer 110 is made of ULE. Zerodur™ or similar.

It should be appreciated that any of a myriad of properties associated with an actuator of the plurality of DM actuators may be varied and that impact their operation and/or associated deformation of a mirror layer. For example, in some embodiments, different DM actuators may be configured based on different thicknesses, shapes, specific heats, emissivity, thermal conductivity, CTEs, and/or the like, such that sensitivity, response time, and/or recovery time of each actuator is optimized to a desired target level. In some embodiments, one or more actuator is made of the same material as the mirror layer 110. In some embodiments, one or more actuators are embodied within a monolithic part of the mirror layer 110, for example based at least in part on the shape, CTE, specific heat, emissivity, and/or thermal conductivity of the material shared by the mirror layer 110 and actuator of the plurality of DM actuators 150.

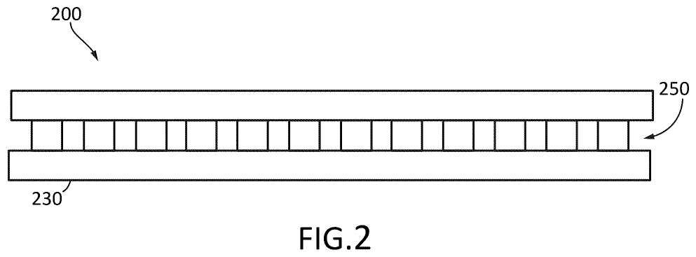

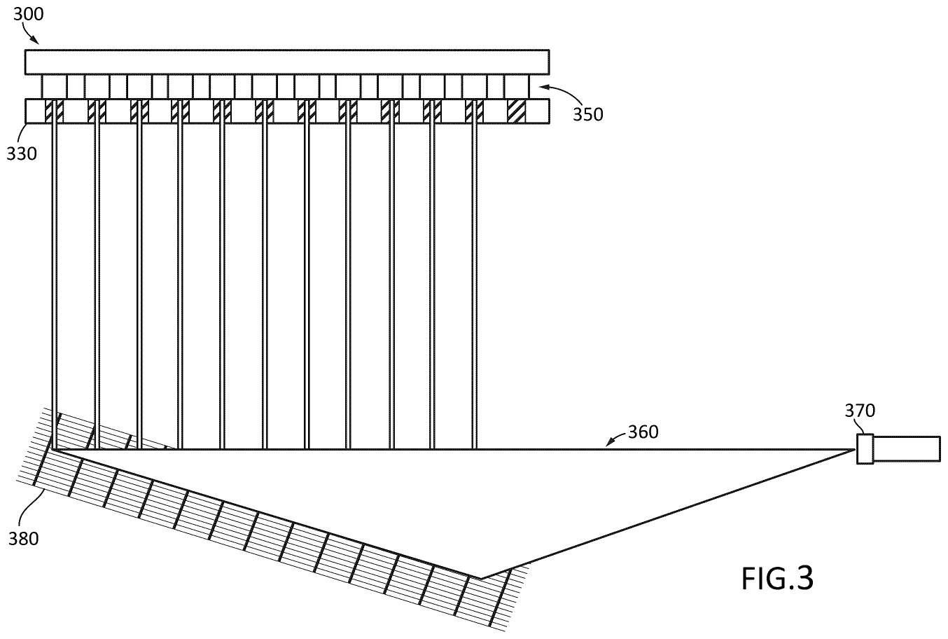

In another aspect, as illustrated in FIG. 1, the reaction structure portion 130 includes a plurality of physical channels or openings 132 corresponding to each unit area of the plurality of unit areas 102. In particular, for example, the reaction structure portion 130 corresponding to the unit area 102a defines a physical channel or opening 132a that allows radiation, and specifically light from a laser beam (depicted in FIGS. 2 and 3), to traverse the reaction structure portion 130 without being significantly absorbed, and to radiantly heat the piston/DM actuator 150a. The same applies for the other unit areas. In this way, in one aspect, each individual actuator (e.g., each individual piston) of the plurality of DM actuators 150 is thermally connected to the reaction structure portion 130 (which is significantly stiffer than the material of the actuators), and configured for thermal expansion (for example, resulting from the application of non-contact radiant heat). In this way, in another aspect, the reaction structure portion 130 is configured to operate as a stable reference plane against which the actuators can push and/or pull. and the reaction structure portion 130 is further configured to operate as a heat sink, for example to remove heat energy from the plurality of DM actuators 150. In this regard, in some embodiments the reaction structure portion 130 returns the elements to a nominal temperature and state of actuation in the absence of radiant heat input.

In some embodiments, the reaction structure portion 130 includes one or more holes. The holes allow for radiant energy to interact with the actuator elements. Additionally or alternatively, in some embodiments, the radiant structure portion 130 is transparent with respect to the radiation source.

In another aspect, as illustrated in FIG. 1, the reaction structure portion 130 is configured as a constant-temperature heat sink using thermoelectric, mechanical, liquid, or other temperature regulating source(s) (not illustrated). Depending on the configuration, the scale and relative proportions of the reaction structure portion 130 may be significantly different from what is illustrated. For example, in one aspect, the reaction structure portion 130 may be relatively thin and space-saving, instead relying on an efficient and effective thermoelectric cooler system to offload approximately the same amount of heat from the actuator as is being put in by a non-contact radiant heat source. In another aspect, the reaction structure portion 130 may be relatively large, instead relying on an efficient and effective thermoelectric cooler system to offload approximately the same amount of heat from the actuator as is being put in by a non-contact radiant heat source. In some embodiments, the thermoelectric cooler balances total radiant power input, or operates as a continuous (or constant) temperature heat sink.

It should be appreciated that any of a myriad of properties associated with the reactive structure portion 130 are varied and that impact their operation and/or effects thereon. For example, in some embodiments, different DM actuators may be configured based on different thicknesses, shapes, specific heats, emissivity, thermal conductivity, CTEs, and/or the like, such that sensitivity, response time, and/or recovery time of each actuator is optimized to a desired target level. In some embodiments, one or more actuator is made of the same material as the mirror layer 110. In some embodiments, one or more actuators are embodied within a monolithic part of the mirror layer 110, for example based at least in part on the shape, CTE, specific heat, emissivity, and/or thermal conductivity of the material shared by the mirror layer 110 and actuator of the plurality of DM actuators 150.

Turning now to FIG. 2, FIG. 2 depicts a perspective view of an illustration of an example of a DM segment. The DM segment includes a plurality of DM actuators, and a transparent or translucent reaction structure portion. In particular, in one aspect, the DM segment 200 is similar to the DM segment 100 of FIG. 1 except for the following detailed differences. In one aspect, the reaction structure portion 230 for the DM segment 200 is transparent or translucent, or has adsorption characteristics allowing light (or one or more types of radiation) to traverse the reaction structure portion 230 and to radiantly heat the plurality of actuators 250. In another aspect, the reaction structure portion 230 is fused silica or BK7™. In another aspect, the reaction structure portion 230 is a material that is transparent or translucent but that also has high thermal conductivity (e.g., that exceeds a target threshold for thermal conductivity, such as for a particular use case).

Turning now to FIG. 3, FIG. 3 is a perspective view of an illustration of an example of a DM segment comprising a plurality of DM actuators and heated by light from a light source distributed using a digital light processing (DLP) chip. The DLP chip may be based on optical, micro-electro-mechanical technology that utilizes a digital micromirror device. In particular, in one aspect, the DM segment 300 is similar to the DM segment 100 of FIG. 1 except for the following detailed differences. In one aspect, light 360 from a light source 370 is spatially-varied and has its intensity varied using a DLP chip 380. In another aspect, the DLP chip 380 comprises a digital micro mirror device having microscopically small mirrors laid out in a matrix on a semiconductor chip, providing a DMD pixel pitch of about 5.4 micrometers (or less, in some embodiments). Moreover, in another aspect, the digital micro mirror device of the DLP chip 380 is configured to be repositioned rapidly to reflect the light 360 onto the targeted actuators of the plurality of actuators 350 (“on”), or for example onto a heat sink (“off”). Furthermore, in another aspect, the DLP chip 380 is configured to rapidly toggle the digital micro mirror device of the DLP chip 380 from a first position (e.g., “on”) to a second position (e.g., “off”), to produce rapid, variable intensity, controlled by the ratio of “on”-time to “off”-time. In this way, in another aspect, the targeted actuators of the plurality of actuators 350 are actuated by the light source 370 and the DLP chip 380, which precisely and accurately deposits heat energy to the targeted actuators without significantly heating the reaction structure portion 330. In this regard, the light source 370 may be varied both spatially and in intensity. The controlled and targeted heating allows for precise control of mirror deformation to influence the mirror's figure, and control the altered reflected wavefront.

In another aspect, as illustrated in FIG. 3, each actuator of the plurality of actuators 350 gets assigned a 4×4 pixel bin of a 4K DLP chip 380 having a total of 2716×528 pixels. In this way, in one aspect, the 4K DLP chip 380 has leftover pixels for redundancy. In another aspect, each actuator of the plurality of actuators 350 gets assigned an equal share of the 2716×528 pixels of the 4K DLP chip 380, which allows for more heat flux over the same period of time and/or a faster update/refresh rate for the system. For example, in one aspect, assuming a mirror diameter of between about 1.0 inch to about 20.0 inches, the light source 370 and the DLP chip 380 could have a control rate (e.g., an update/refresh rate) in the hertz range. Moreover, in another aspect, the light source 370 and the DLP chip 380 could provide steady state flux and have a control rate (e.g., an update/refresh rate) in the hertz range that prevents relaxation/contraction of the actuators/pistons between heating instances.

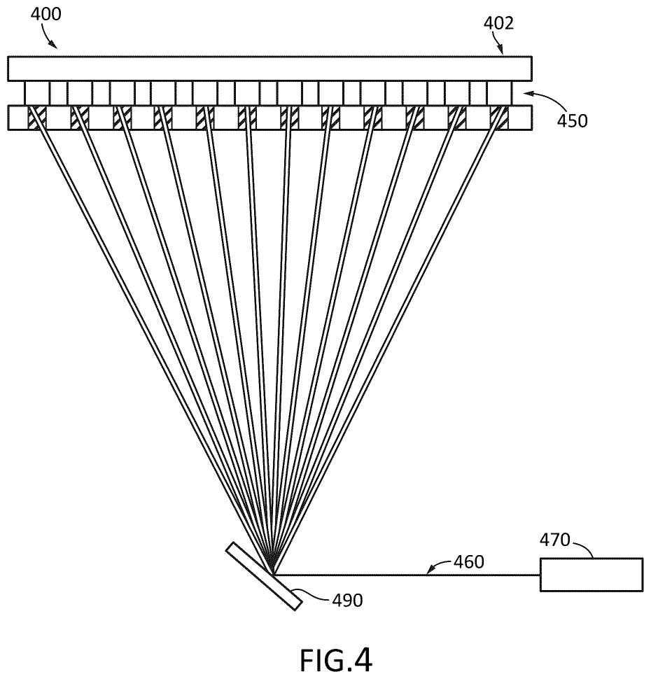

Turning now to FIG. 4, FIG. 4 is a perspective view of an illustration of an example of a DM segment comprising a plurality of DM actuators and heated by light from a light source distributed using a fast-steering mirror. In particular, in one aspect, the DM segment 400 is similar to the DM segment 100 of FIG. 1 except for the following differences. In one aspect, the light source is a modulated laser 470, and light 460 from the modulated laser 470 is spatially-varied and has its intensity varied using a fast-steering mirror 490. In another aspect, the modulated laser 470 is modulated for power or modulated for “on”/“off” duration, to provide a specific quantity of intended heat flux to the plurality of DM actuators 450. For example, the modulated laser 470 may be modulated to cause skipping and/or depositing of heat into one or more actuator elements.

In another aspect, in an embodiment, multiple modulated lasers 470 (not illustrated) are provided for situation where the refresh/update rate of a single modulated laser 470 would be insufficient, for example with selective laser-melt 3D printing systems. Furthermore, in another aspect, multiple modulated lasers 470 (not illustrated) are provided in some embodiments, for example where a single modulated laser 470 could become non-functional thus allowing for redundant light sources and removing the risk of a dead pixel/dead unit area 402 of the DM segment 400, or of an entirely dead DM segment 400.

In another aspect, in an embodiment, the light source is a modulated laser similar to a selective melt additive manufacturing laser that tracks at about 7.0 meter per second. Assuming a mirror diameter of between about 1.0 inch to about 20.0 inches, the overall system would have a control rate (e.g., an update/refresh rate) in the sub-hertz to single-digit hertz range. In one aspect, for example, the laser could hit about 10,000 actuators/pistons, for a mirror diameter of between about 1.0 inch to about 4.0 inches, about once or twice per second.

It will be appreciated that, in some embodiments, one or more other light sources may be utilized. A different light source may be spatially-varied and/or intensity-varied. In some embodiments, the light source comprises or is embodied by a fiber optic. The fiber optic in some embodiments radiates light that reaches the reaction structure layer and applies non-contact, radiant heat through the reaction structure layer to one or more of a plurality of DM actuators. Specifically, in some embodiments, modulated light is delivered to discrete actuators (e.g., pistons) of the plurality of actuators via a fiber optic cable (or multiple fiber optic cables). Additionally or alternatively, in some embodiments the light source includes a liquid crystal display (LCD) mask, which is applied to light to spatially-vary and/or intensity-vary the light. In this regard, the LCD mask blocks light from reaching unwanted areas, such that the areas where light is desired (e.g., to provide a particular intensity of non-contact heat to one or more actuators) continue to receive light through the mask and other areas do not. It will be appreciated that, in some such embodiments and in any such implementation, the light source embodies a non-contact heat source, which provides non-contact heat (e.g., radiant heat) to the plurality of actuators as depicted and described herein.

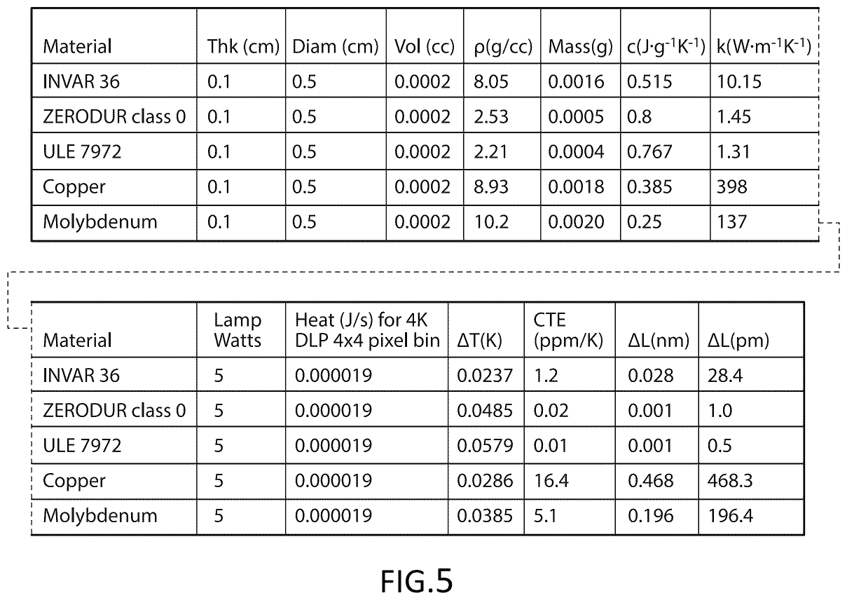

Turning now to FIG. 5, FIG. 5 is a table showing the stroke length of a DM actuator made possible by different materials. In particular, in one aspect, the table 500 shows the stroke lengths made possible when different materials (e.g., INVAR 36™, ZERODUR™ class 0, ULE 797™, copper, and molybdenum) are heated by a 4K DLP 4×4 pixel bin (e.g., a 4K DLP chip has a total of 2716×528 mirrors) for the listed amount of radiant heat (or heat flux) over one second of flux, using a 5-watt lamp. In another aspect, INVAR 36 shows a stroke length of approximately 28.4 picometers for the listed heat flux, which implies that INVAR 36 can provide single digit picometer control using a minimal amount of heat flux (which are NASA™-type deformable mirror requirements). In another aspect, copper shows a stroke length of approximately 0.5 nanometers for approximately the listed heat flux, which implies that copper can provide single digit nanometer control using approximately the same amount of heat flux (which are commercial application type requirements).

Having described example deformable mirrors, deformable mirror segments, apparatuses, and related implementation details, example processes in accordance with the present disclosure will now be discussed. In some embodiments, a process embodies a method for using a deformable mirror. In some embodiments, the method is by one or more computers, devices, systems, apparatuses, and/or the like discussed herein that interact with and use the deformable mirror. For example, in some embodiments, the process is implemented via digital light processing (DLP) machine, telescope, or other optical system.

In some embodiments, a process may include one or more optional operation. As illustrated, an optional operation may be depicted in dashed (or “broken”) lines, indicating that the operation is optional. In some embodiments, all optional operations are performed as part of the process. In some embodiments, some optional operations are performed as part of the process. In some embodiments, none of the optional operations are performed as part of the process.

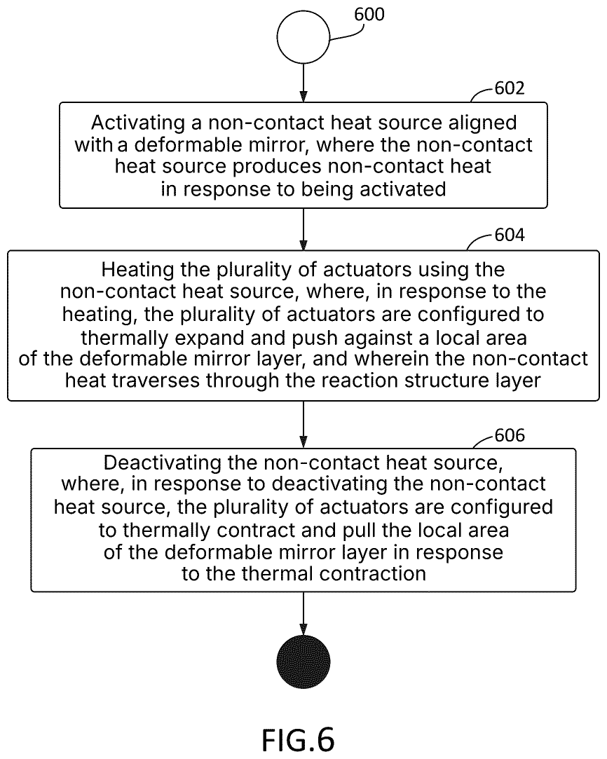

FIG. 6 depicts operations of deforming a mirror for using the deformable mirror in accordance with at least some embodiments of the disclosure. In some embodiments, a deformable mirror, such as those discussed above, are deformed in accordance with the process depicted and described. In some embodiments, the deformable mirror is deformed as part of using a particular optical system, for example by a DLP device as part of performing a particular use case.

At operation 602, the process 600 includes activating a non-contact heat source aligned with a deformable mirror. The non-contact heat source produces non-contact heat in response to being activated. In some embodiments, the deformable mirror includes a deformable mirror layer, a reaction structure layer, and a plurality of actuators. The plurality of actuators is disposed between the deformable mirror layer and the reaction structure layer. The plurality of actuators may be connected to or otherwise engage the back of the deformable mirror layer.

In some embodiments, at least one light source includes a DLP chip. The DLP chip in some embodiments includes one or more moveable light sources and/or mirrors that radiate light as a non-contact heat source, and that heats the plurality of actuators. Additionally or alternatively, in some embodiments the non-contact heat source includes at least one modulated laser, or a plurality of modulated lasers. In some embodiments the at least one modulated laser includes a fast-steering mirror. In some embodiments, at least one light source includes or is embodied by, and/or is spatially-varied using, a transparent Liquid Crystal Display (LCD) as a mask. In some embodiments, modulated light is delivered to discrete pistons via a fiber optic cable.

At operation 604, the process 600 includes heating the plurality of actuators using the non-contact heat source. In some embodiments, the non-contact heat produced by the activated non-contact heat source heats the plurality of actuators through radiant heating. The non-contact heat traverses through the radiation structure layer to heat the plurality of actuators. In some embodiments, the non-contact heat source is a light source that projects light to and/or towards the plurality of actuators, where the light heats at least one of the plurality of actuators. In response to the heating, the plurality of actuators are configured to thermally expand and push against a local area of the deformable mirror layer. In this regard, the thermal expansion of a particular actuator deforms a corresponding location of the deformable mirror. In some embodiments, each actuator is heated to reach a target deformation of the deformable mirror at a particular location. It should be appreciated that the plurality of actuators thus may be actuated to different target amounts in response to the same applied heat (e.g., the same amount of applied heat may differently actuate different actuators).

At operation 606, the process 600 includes deactivating the non-contact heat source. In response to deactivating the non-contact heat source, the plurality of actuators are configured to thermally contract and pull the local area of the deformable mirror layer in response to the thermal contraction. In some embodiments, the plurality of actuators are cooled and thus contract due to the non-contact heat no longer being supplied. Additionally or alternatively, in some embodiments, the plurality of actuators dissipate heat to one or more heat sinks, for example of the reaction structure layer.

### V. Implementations

Certain implementations of systems and methods consistent with the present disclosure are provided as follows:

Clause 1. A deformable mirror comprising: a deformable mirror layer; a reaction structure layer; and a plurality of actuators between the deformable mirror layer and the reaction structure layer, wherein the plurality of actuators engage the back of the deformable mirror layer and each actuator of the plurality of actuators is configured to push against a local area of the deformable mirror layer in response to thermal expansion from a non-contact heat source and/or pull the local area of the deformable mirror layer in response to thermal contraction from the non-contact heat source.

Clause 2. The deformable mirror of any one of the preceding example Clauses, wherein the plurality of actuators are configured to each actuate to a target amount based on a thickness, a shape, a coefficient of thermal expansion, a specific heat, an emissivity, or a thermal conductivity.

Clause 3. The deformable mirror of any one of the preceding example Clauses, wherein the reaction structure layer comprises a heat sink that dissipates heat from the plurality of actuators to a stable state.

Clause 4. The deformable mirror of example Clause 3, wherein the heat sink regulates temperature utilizing a thermoelectric source, a mechanical source, or a liquid source.

Clause 5. The deformable mirror of any one of the preceding example Clauses, wherein the plurality of actuators comprises different actuators that actuate to different target amounts in response to a same applied heat.

Clause 6. The deformable mirror of any one of the preceding example Clauses, wherein the plurality of actuators comprises a discrete thermal expansion piston.

Clause 7. The deformable mirror of any one of the preceding example Clauses, wherein the deformable mirror layer comprising a coating with a thickness at each location of the deformable mirror location, wherein the thickness at a location defines deformation of the location that adjusts a reflected waveform to a desired waveform.

Clause 8. The deformable mirror of any one of the preceding example Clauses, wherein the reaction structure layer comprises a plurality of channels corresponding to a plurality of local areas of the deformable mirror layer.

Clause 9. The deformable mirror of example Clause 8, wherein the plurality of local areas are each aligned with at least one light source, wherein light from the at least one light source traverses through at least one of the plurality of channels to heat at least one actuator of the plurality of actuators.

Clause 10. The deformable mirror of any one of the preceding example Clauses, wherein the reaction structure layer comprises a stable plane against which the plurality of actuators performs the push and the pull.

Clause 11. The deformable mirror of any one of the preceding example Clauses, wherein the reaction structure layer comprises a transparent or a translucent layer, wherein the transparent layer or the translucent layer has a thermal conductivity that exceeds a target threshold.

Clause 12. The deformable mirror of any one of the preceding example Clauses, wherein the plurality of actuators are aligned with the non-contact light source comprising a digital light processing (DLP) chip, wherein light from the DLP chip applies non-contact radiant heat to the plurality of actuators.

Clause 13. A deformable mirror segment comprising: a deformable mirror layer; a reaction structure layer; a plurality of actuators between the deformable mirror layer and the reaction structure layer; and at least one light source aligned with the plurality of actuators, wherein the plurality of actuators engage the back of the deformable mirror layer and each actuator of the plurality of actuators is configured to push against a local area of the deformable mirror layer in response to thermal expansion from non-contact heat sourced from the at least one light source and/or pull the local area of the deformable mirror in response to thermal contraction from removal of the non-contact heat sourced from at least one light source.

Clause 14. The deformable mirror segment of example Clauses 13, wherein at least one light source comprises at least one modulated laser.

Clause 15. The deformable mirror segment of example Clause 14, wherein the at least one modulated laser comprises a fast-steering mirror.

Clause 16. The deformable mirror segment of any one of example Clauses 13-15, at least one light source is spatially varied using a digital light processing chip.

Clause 17. The deformable mirror segment of any one of example Clauses 13-16, at least one light source is spatially varied using a transparent Liquid Crystal Display (LCD) as a mask.

Clause 18. The deformable mirror segment of any one of example Clauses 13-17, modulated light is delivered to discrete pistons via a fiber optic cable.

Clause 19. A method comprising: activating a non-contact heat source aligned with a deformable mirror, wherein the non-contact heat source produces non-contact heat in response to being activated, wherein the deformable mirror comprises a deformable mirror layer, a reaction structure layer, and a plurality of actuators between the deformable mirror layer and the reaction structure layer; heating the plurality of actuators using the non-contact heat source, wherein, in response to the heating, the plurality of actuators are configured to thermally expand and push against a local area of the deformable mirror layer, and wherein the non-contact heat traverses through the reaction structure layer; and deactivating the non-contact heat source, wherein, in response to deactivating the non-contact heat source, the plurality of actuators are configured to thermally contract and pull the local area of the deformable mirror layer in response to the thermal contraction.

Clause 20. The method of example Clause 19, wherein the non-contact heat source comprises a digital light processing chip.

Clause 21. The method of any one of example Clauses 19-20, wherein the non-contact heat source comprises at least one modulated laser.

Clause 22. The method of any one of example Clauses 19-20, wherein the non-contact heat source is spatially varied using a transparent Liquid Crystal Display (LCD) as a mask. S

Clause 23. The method of any one of example Clauses 197-22, wherein the plurality of actuators actuate to different target amounts in response to a same applied heat.

Clause 24. The method of any one of example Clauses 19-22, wherein modulated light is delivered to discrete pistons via a fiber optic cable.

### V. Conclusion

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A deformable mirror comprising:
a deformable mirror layer;
a reaction structure layer; and
a plurality of actuators between the deformable mirror layer and the reaction structure layer,
wherein the plurality of actuators engage the back of the deformable mirror layer and each actuator of the plurality of actuators is configured to push against a local area of the deformable mirror layer in response to thermal expansion from a non-contact heat source or pull the local area of the deformable mirror layer in response to thermal contraction from the non-contact heat source.

2. The deformable mirror of claim 1, wherein the plurality of actuators are configured to each actuate to a target amount based on a thickness, a shape, a coefficient of thermal expansion, a specific heat, an emissivity, or a thermal conductivity.

3. The deformable mirror of claim 1, wherein the reaction structure layer comprises a heat sink that dissipates heat from the plurality of actuators to a stable state.

4. The deformable mirror of claim 3, wherein the heat sink regulates temperature utilizing a thermoelectric source, a mechanical source, or a liquid source.

5. The deformable mirror of claim 1, wherein the plurality of actuators comprises different actuators that actuate to different target amounts in response to a same applied heat.

6. The deformable mirror of claim 1, wherein the plurality of actuators comprises a discrete thermal expansion piston.

7. The deformable mirror of claim 1, wherein the deformable mirror layer comprising a coating with a thickness at each location of the deformable mirror location, wherein the thickness at a location defines deformation of the location that adjusts a reflected waveform to a desired waveform.

8. The deformable mirror of claim 1, wherein the reaction structure layer comprises a plurality of channels corresponding to a plurality of local areas of the deformable mirror layer.

9. The deformable mirror of claim 8, wherein the plurality of local areas are each aligned with at least one light source, wherein light from the at least one light source traverses through at least one of the plurality of channels to heat at least one actuator of the plurality of actuators.

10. The deformable mirror of claim 1, wherein the reaction structure layer comprises a stable plane against which the plurality of actuators performs the push or the pull.

11. The deformable mirror of claim 1, wherein the reaction structure layer comprises a transparent or a translucent layer, wherein the transparent layer or the translucent layer has a thermal conductivity that exceeds a target threshold.

12. The deformable mirror of claim 1, wherein the plurality of actuators are aligned with the non-contact light source comprising a digital light processing (DLP) chip, wherein light from the DLP chip applies non-contact radiant heat to the plurality of actuators.

13. A deformable mirror segment comprising:
a deformable mirror layer;
a reaction structure layer;
a plurality of actuators between the deformable mirror layer and the reaction structure layer; and
at least one light source aligned with the plurality of actuators,
wherein the plurality of actuators engage the back of the deformable mirror layer and each actuator of the plurality of actuators is configured to push against a local area of the deformable mirror layer in response to thermal expansion from non-contact heat sourced from the at least one light source or pull the local area of the deformable mirror in response to thermal contraction from removal of the non-contact heat sourced from at least one light source.

14. The deformable mirror segment of claim 13, wherein at least one light source comprises at least one modulated laser.

15. The deformable mirror segment of claim 14, wherein the at least one modulated laser comprises a fast-steering mirror.

16. The deformable mirror segment of claim 13, wherein the at least one light source is spatially varied using a digital light processing chip.

17. A method comprising:
activating a non-contact heat source aligned with a deformable mirror, wherein the non-contact heat source produces non-contact heat in response to being activated,
wherein the deformable mirror comprises a deformable mirror layer, a reaction structure layer, and a plurality of actuators between the deformable mirror layer and the reaction structure layer;
heating the plurality of actuators using the non-contact heat source, wherein, in response to the heating, the plurality of actuators are configured to thermally expand and push against a local area of the deformable mirror layer, and wherein the non-contact heat traverses through the reaction structure layer; and
deactivating the non-contact heat source, wherein, in response to deactivating the non-contact heat source, the plurality of actuators are configured to thermally contract and pull the local area of the deformable mirror layer in response to the thermal contraction.

18. The method of claim 17, wherein the non-contact heat source comprises a digital light processing chip.

19. The method of claim 17, wherein the non-contact heat source comprises at least one modulated laser.

20. The method of claim 17, wherein the non-contact heat source comprises a liquid crystal display (LCD) mask, or the non-contact heat is delivered to discrete actuators of the plurality of actuators via a fiber optic cable.
